(19) United States
(12) Patent Application Publication
(10) Pub. No.: US 2023/0335010 A1
(43) Pub. Date: Oct. 19, 2023

(54) ANATOMICAL MODEL OF A JAW FOR SIMULATING A DENTISTRY GESTURE

(71) Applicant: DENTALHITEC, MAZIE-RES-EN-MAUGES (FR)

(72) Inventor: Olivier VILLETTE, MAZIÈRES-EN-MAUGES (FR)

(21) Appl. No.: 18/026,899

(22) PCT Filed: Sep. 10, 2021
(86) PCT No.: PCT/FR2021/051556

§ 371 Date: Mar. 17, 2023

(30) Foreign Application Priority Data
Sep. 17, 2020 (FR) 20 09 403

(51) Int. Cl. G09B 23/28

(52) U.S. Cl. CPC G09B 23/283; G09B 23/285

(57) ABSTRACT

An anatomical model of a maxilla of a living being, including a gingiva representing the maxilla of said living being, the anatomical model having at least one guide for a tool integrated into the gingiva to allow an operator to simulate a dentistry gesture.

### TECHNICAL FIELD

The disclosure relates to the field of dental care, and more particularly to the learning of techniques and dentistry procedures such as anesthesia.

### BACKGROUND

In many professions, it is essential to practice the different techniques before putting them into practice. Practicing, allowing safe and precise gestures to be adopted, is all the more important in professions, e.g. dentists, dealing with living beings so as not to cause injury to them or to hurt them.

A dentist has to learn many techniques with all the specificities thereof. In addition, techniques are constantly evolving and new techniques are developed, forcing dentists to train and constantly practice new techniques.

To train, dentists can practice on patients, under the supervision of a trainer. This practice allows the trainee dentist to perfectly feel the sensations he/she should feel for each of the techniques learned.

However, since the trainee dentist does not yet fully control his/her actions, the method carries a risk of injury or pain for the patient.

Indeed, for injecting under good conditions, e.g. during intraosseous anesthesia, it is necessary to approach the end of the roots of teeth, because if the injection is not performed sufficiently deeply, the area is less vascularized which can entail bone necrosis depending on the injected product. Also, going below the roots of the teeth is prohibited, otherwise lesions can occur. It is also important not to push the needle down to the guard, so that the needle can be easily removed if same breaks.

The depth of penetration of the needle is thus an essential element for performing an anesthesia without post-operative concern.

To train, dentists can also practice by simulating gestures on anatomical models of the jaw including an anatomical model of an upper jaw and an anatomical model of a lower jaw.

Such anatomical models have the advantage of grouping in a single model, many cases which can be encountered with patients. Such anatomical models also make it possible to prevent any risk for a patient while a dentist does not have complete control of over his/her gestures.

However, the existing anatomical jaw models do not allow the trainee dentist to see the correct angulations, the depths of penetration and even less to feel the sensations that he/she will feel when practicing the techniques learned on a patient.

The goal of the disclosure is to propose an anatomical model of the maxilla for simulating anesthesia techniques allowing the dentist to exercise alone while acquiring the most precise gestures possible in order to effectively treat his/her future patients without the risk of injuring or hurting the patients.

To this end, first of all, an anatomical model of a maxilla of a living being is proposed comprising a gingiva representing the maxilla of said living being.

Such anatomical model allows a dentist to practice dental techniques without the risk of injuring or hurting a patient.

The anatomical model further comprises at least one tool guide integrated into the gingiva so as to allow an operator to simulate a dentistry gesture.

The anatomical model allows the dentist to exercise alone while acquiring the most precise gestures possible.

Various additional features can be provided, alone or in combination:
the guide crosses the gingiva and comprises a needle orientation slide extending into the gingiva and forming a substantially cylindrical hole through the gingiva allowing a dentist to practice an anesthesia technique;
the slide forms an angle between the roots of the teeth and the cortical plate with a direction along which the needle arrives between the roots or into the spongy bone if the septum is not present;
the guide comprises a main inner wall arranged in the slide across said hole so that a needle inserted into the slide perforates the main inner wall to simulate the piercing of the cortical plate bone;
a thickness of the main inner wall along the direction of insertion of the needle is between 0.1 and 2 mm plus or minus 20%;
the anatomical model comprises at least one tooth arranged on the gingiva;
the guide comprises at least one secondary inner wall arranged in the slide across said hole, the secondary inner wall being arranged downstream of the main inner wall along the direction of insertion of the needle, so that a needle inserted into the slide perforates first the main inner wall and then the secondary inner wall to simulate the piercing of the cortical bone and then the trabecular bone of the maxilla;
a thickness of the at least one secondary inner wall along the direction of insertion of the needle is comprised between 0.1 and 2 mm plus or minus 20%;
the guide comprises at least two secondary inner walls separated from each other and from the main inner wall by a distance comprising between 0.3 and 2 mm plus or minus 20%;
the guide comprises a stop aligned with the hole formed by the slide and arranged upstream of the slide along the direction of insertion of the tool in order to teach the dentist which is the correct depth of insertion of the tool;
the stop being arranged at a distance between 2 and 7 mm plus or minus 20% from the main inner wall;
the guide comprises a protective wall of the free end of the needle, the protective wall being aligned with the hole formed by the slide and arranged downstream of the slide along the direction of insertion of the needle to protect the dentist during a manipulation of the anatomical model after an insertion of the needle;
the protective wall comprises a viewing window of the free end of the needle allowing the practitioner to see the location of the end of the needle;
the guide comprises a needle orientation slide, the slide forming an angle of 10 degrees plus or minus 20% with a direction tangent to the point of contact of the needle on the gingiva.

Secondly, a setup is proposed for simulating anesthesia techniques, the setup comprising an anatomical model of an upper jaw of a living being as described hereinabove, an anatomical model of a lower jaw of a living being as described hereinabove and a model of a circumoral area of the living being, each anatomical model comprising a means of rigid attachment to the circumoral area model, the circumoral area model comprising a means of spatial attachment and an opening allowing the two anatomical models to be seen.

Thirdly, a method for simulating anesthesia techniques is proposed, the method comprising an insertion of the needle of a syringe into a hole of a gingiva representing a maxilla of a living being, the hole being formed by a slide of a guide integrated into the gingiva, a perforation of a main inner wall of the guide, the main inner wall being arranged in the slide across said hole, and a sight of the free end of the syringe through a viewing window.

### BRIE DESCRIPTION OF THE DRAWINGS

The disclosure will be better understood, and other goals, features, details and advantages thereof will become clearer from the following explanatory description with reference to the enclosed drawings given only as an example illustrating a plurality of embodiments of the disclosure and wherein:

FIG. 1 is a schematic view from a first perspective of an embodiment of an anatomical model of a jaw comprising two anatomical models of upper and lower jaws including guides for the simulation of anesthesia techniques;

FIG. 2 is a schematic view from a second perspective of the anatomical model of the jaw shown in FIG. 1; a syringe inserted in a guide is shown;

FIG. 3 is a schematic view from a third perspective of the anatomical model of the jaw shown in FIGS. 1 and 2; a syringe inserted in a guide is shown;

FIG. 4A is a schematic view from a first perspective of a first embodiment of the guides;

FIG. 4B is a schematic view from a second perspective of the first embodiment of the guides;

FIG. 4C is a schematic view of a section of the first embodiment of the guides along the plane IVc shown in FIG. 4A;

FIG. 5A is a schematic view from a first perspective of a second embodiment of the guides;

FIG. 5B is a schematic view of a section of the second embodiment of the guides along the plane Vb shown in FIG. 5A;

FIG. 6 is a schematic perspective view of a first embodiment of the guides;

FIG. 7 is a schematic perspective view of a simulation setup comprising an anatomical model of a jaw and a model of a circumoral area;

FIG. 8A is a schematic view from a first perspective of a variant of the first embodiment of the guides, said variant simulating a cortical plate of a child patient while the variant illustrated in FIGS. 4A to 4C simulates a cortical plate of an adult patient;

FIG. 8B is a schematic view of a section of the variant of the first embodiment of the guides along the plane VIIIb shown in FIG. 8A.

### DETAILED DESCRIPTION

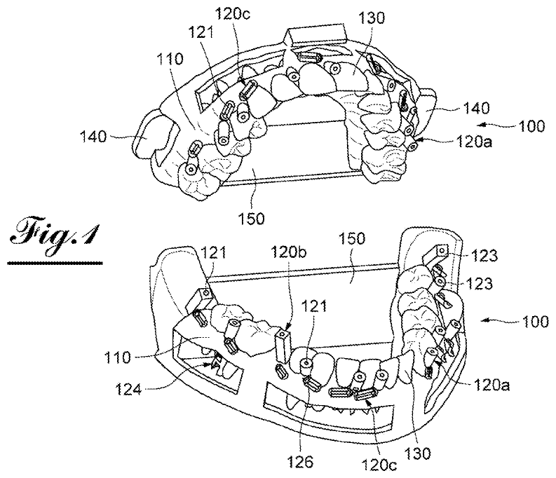

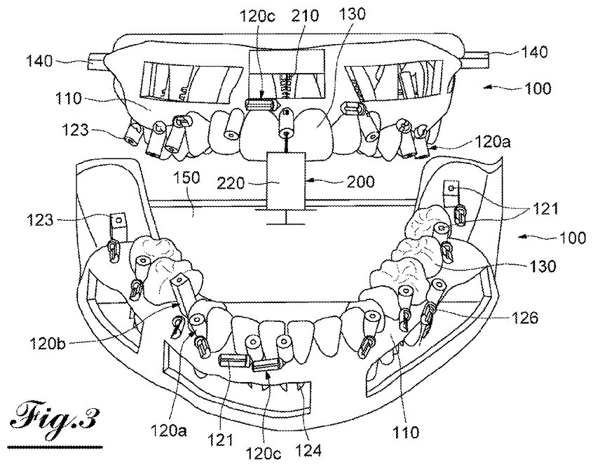

FIGS. 1 to 3 show an anatomical model of jaw comprising an anatomical model 100 of the upper jaw and an anatomical model 100 of the lower jaw of a living being.

According to the embodiment shown, every anatomical model 100 comprises a gingiva 110 and teeth 130.

The teeth 130 preferentially have features, such as spacing, angle or size, recreating a large number of cases which can be found in such a living being.

According to the illustrated embodiment, every anatomical model 100 further comprises guides 120a, 120b, 120c, 120d for simulating anesthesia techniques. The guides 120a, 120b, 120c, 120d comprise a slide 121 for sliding the needle 210 of a syringe 200 which a trainee dentist pushes into the gingiva 110 along the slide 121 to teach the trainee dentist the appropriate gesture.

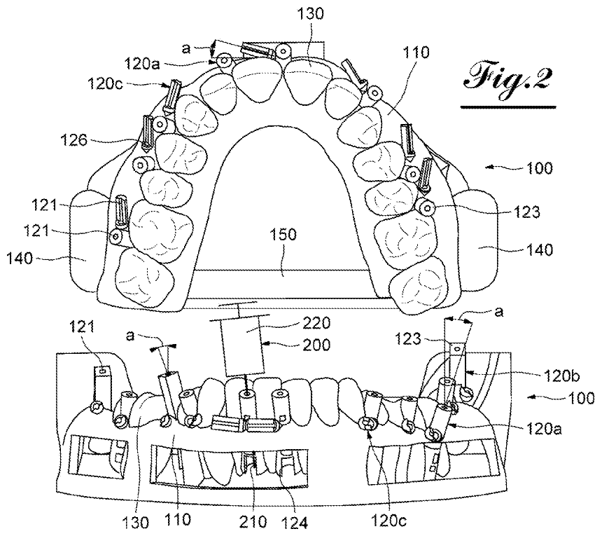

As shown in FIG. 2, the guides 120a, 120b, 120c, 120d preferentially form an angle a comprised between 10° and 90° with respect to a part of the anatomical model 100. The angle a is different according to each type of anesthesia represented by the guides 120a, 120b, 120c, 120d.

The angle a allows the trainee dentist to acquire the gesture corresponding specifically to the anesthesia technique for which he/she trains

The guides 120a, 120b, 120c, 120d further preferentially comprise: a stop 123 and/or a stop face 126 blocking the penetration of the syringe 200 to a certain depth into the gingiva 110. The depth of penetration depends on the type of anesthesia represented by the guide 120a, 120b, 120c, 120d.

The depth of penetration once again allows the trainee dentist to make his/her gesture more precise according to the technique of anesthesia for which he/she trains.

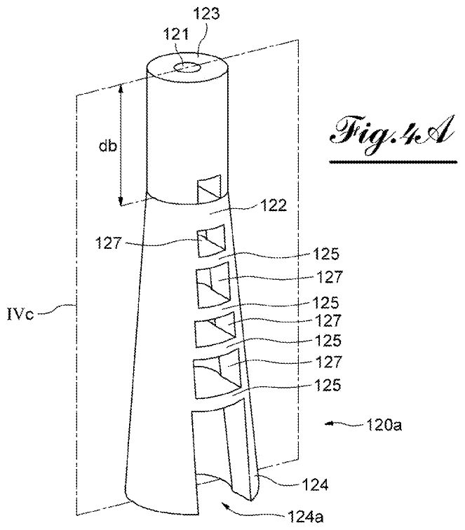

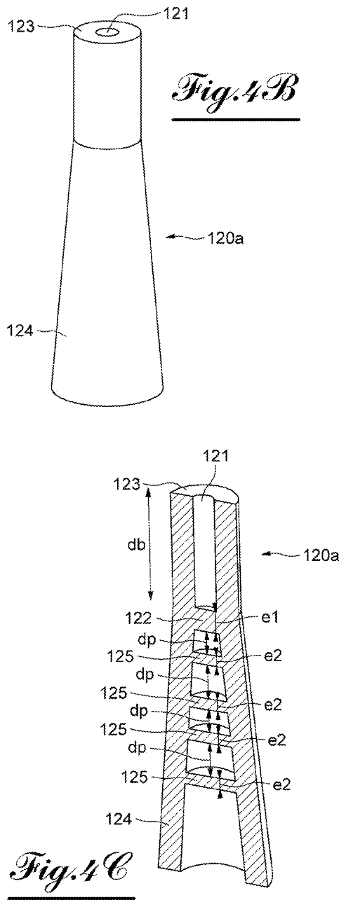

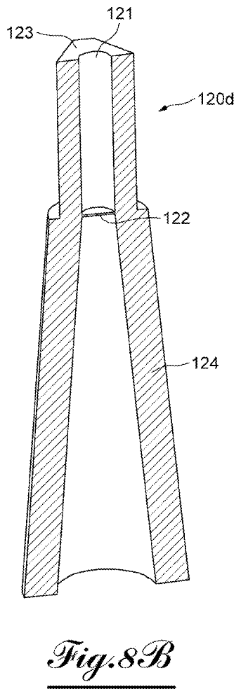

FIGS. 4A to 4C and FIGS. 8A and 8B show a first embodiment of the guide 120a, 120d. Such embodiment can be used for a simulation of intraosseous anesthesia in a region of the jaw comprising a septum and hence a relatively developed trabecular bone.

The first embodiment of the guide 120a, 120d is preferentially arranged in a zone comprising a tooth 130 of the anatomical model 100 of a maxilla.

According to such first embodiment, the slide 121 forms a hole in the gingiva 110. The hole is e.g. cylindrical with a circular base. The diameter of the hole is greater than the diameter of the needle 210.

According to the first embodiment, the tube crosses through the top of the septum and heads between the roots of the 2 teeth.

According to the embodiment shown in FIGS. 4A to 4C, the slide 121 is divided into at least three sections by a main inner wall 122 and by at least one secondary inner wall 125 arranged across the slide 121.

The main inner wall 122 and the secondary inner wall or walls 125 are arranged and configured along the slide 121 so that the needle 210 of a syringe 200 pushed in, in the first embodiment of the guide 120a along the slide 121, crosses first through the main inner wall 122 and then, secondly, the secondary inner wall or walls 125.

The main inner wall 122 thus represents the cortical bone of the maxilla. The secondary inner wall or walls 125 thus represent the trabecular bone of the maxilla.

The variant of the first embodiment of the guide 120d, illustrated in FIGS. 8A and 8B, simulates what can be felt on a child's jaw and preferentially does not comprise any secondary inner wall 125.

The thickness e1 of the main inner wall 122 in the version simulating a cortical plate of an adult patient of the first embodiment, shown in FIGS. 4A to 4C, is preferentially 2 mm plus or minus 20%.

The thickness e1 of the main inner wall 122 in the version simulating a cortical plate of a child patient of the first embodiment, shown in FIGS. 8A and 8B, is preferentially comprised between 0.1 mm and 1 mm plus or minus 20%.

The thickness e2 of the secondary inner wall or walls 125 in the first embodiment is preferentially comprised between 0.1 mm and 2 mm plus or minus 20%.

The distance dp separating the main inner wall 122 and the secondary inner wall or walls 125, in the first embodiment, is preferentially comprised between 0.5 and 2 mm plus or minus 20%.

According to the embodiment illustrated in FIGS. 4A to 4C and FIGS. 8A and 8B, the guide 120a, 120d comprises a stop 123 configured for blocking the body 220 of the syringe 200.

The distance db separating the stop 123 and the main inner wall 122 in the first embodiment is preferentially comprised between 0.5 mm and 2 mm plus or minus 20%.

The first embodiment of the guide 120a, 120d preferentially comprises, beyond the last inner wall 122, 125 along the direction of insertion of the needle 210 into the guide 120a, a protective wall 124.

The protective wall 124 is configured for protecting the trainee dentist against a prick during the manipulation of the anatomical model 100 of a maxilla after having inserted the syringe 200 into the guide 120a.

The protective wall 124 has e.g. a flared shape to simulate the zone wherein the free end of the needle 210 can reach after being pushed-in into the guide 120a, 120d.

The protective wall 124 preferentially comprises a window 124a for viewing the free end of the needle 210.

The viewing window 124a allows the trainee dentist to evaluate the depth of insertion of the needle 210 into the gingiva 110 for intraosseous anesthesia in a region of the jaw comprising a septum.

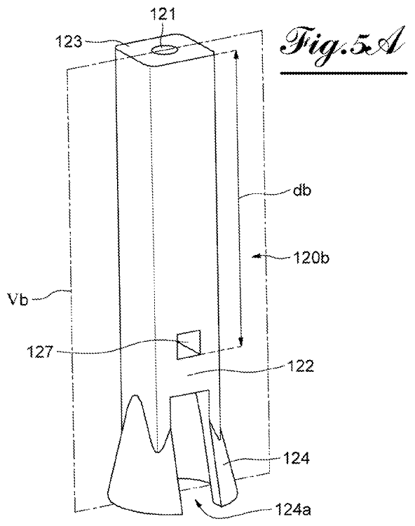

FIGS. 5A and 5B show a second embodiment of the guide 120b. Such embodiment can be used for the simulation of intraosseous anesthesia in an area of the jaw which does not comprise any septum and hence a not very developed trabecular bone.

The second embodiment of the guide 120b is preferentially arranged in an edentulous zone of the anatomical model 100 of a maxilla.

According to the second embodiment, the slide 121 forms a hole in the gingiva 110.

According to the second embodiment, the angle a formed between the guide 120b and the cortical bone plate at said location is comprised between 70° and 110°.

According to the embodiment shown in FIGS. 5A and 5B, the slide 121 is divided into two sections by a main inner wall 122 arranged across the slide 121.

The main inner wall 122 is arranged and configured along the slide 121 so that the needle 210 of a syringe 200 pushed-in, in the second embodiment of the guide 120b, along the slide 121 crosses through the main inner wall 122.

The main inner wall 122 thus represents the cortical bone of the maxilla.

The thickness e1 of the main inner wall 122 in the second embodiment is preferentially comprised between 0.1 mm and 2 mm plus or minus 20% (e.g. to differentiate a version simulating a cortical plate of a child patient from an adult patient).

According to the embodiment illustrated in FIGS. 5A and 5B, the guide 120b comprises a stop 123 configured for blocking the body 220 of the syringe 200.

The distance db separating the stop 123 and the main inner wall 122 in the second embodiment is preferentially comprised between 0.5 mm and 2 mm plus or minus 20%.

The second embodiment of the guide 120b preferentially comprises, beyond the main inner wall 122 along the direction of insertion of the needle 210 into the guide 120b, a protective wall 124.

The protective wall 124 is configured for protecting the trainee dentist against a prick during the manipulation of the anatomical model 100 of a maxilla, after having pushed in the syringe 200 into the guide 120b.

The protective wall 124 has e.g. a flared shape to simulate the area in which the free end of the needle 210 can reach after being pushed-in into the guide 120b.

The protective wall 124 preferentially comprises a window 124a for viewing the free end of the needle 210.

The viewing window 124a allows the trainee dentist to appreciate the depth of insertion of the needle 210 into the gingiva 110 for intraosseous anesthesia in an area of the jaw which does not comprise a septum.

The first and second embodiments of the guide 120a, 120b, 120d preferentially have a different outer shape enabling same to be differentiated when the guides 120a, 120b, 120d are arranged on the same anatomical model 100 of a maxilla.

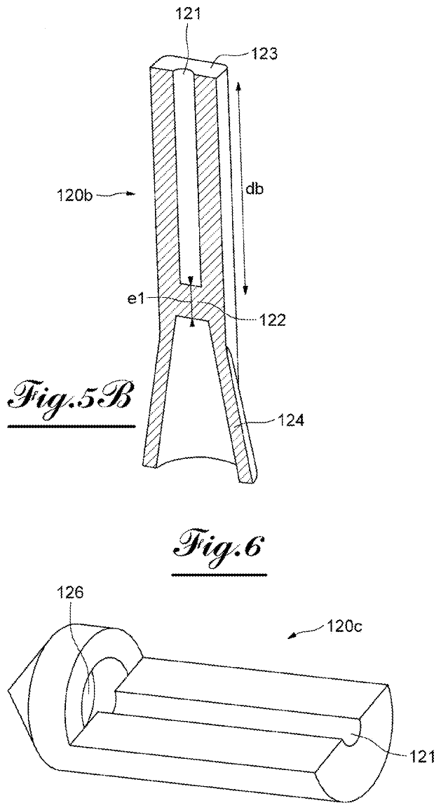

FIG. 6 shows a third embodiment of the guide 120c. The embodiment can be used for simulating an anesthesia of the mucous membrane of a patient.

According to the third embodiment, the slide 121 is outside the gingiva 110.

The slide 121 is preferentially open, leaving the trainee dentist the possibility to see all of the needle 210.

According to the third embodiment, the angle a formed between the guide 120c and a tangent to the point of contact of the needle 210 with the gingiva 110 is 10 degrees plus or minus 10 percent.

According to the embodiment illustrated in FIG. 6, the guide 120c comprises a stop face 126 configured for blocking the penetration of the free end of the needle 210.

According to one embodiment, the guides 120a, 120b, 120c, 120d are made of resin.

According to one embodiment, the guides 120a, 120b, 120c, 120d are manufactured by 3D printing.

In the first and second embodiments, the guide 120a, 120b, 120d preferentially comprises: above each inner wall 122, 125 along the direction of penetration of the needle 210 into the guide 120a, 120b, 120d, an opening 127 for removing the material during the manufacture of the guides 120a, 120b, 120d.

The thicknesses e1, e2 of the main and secondary inner walls 122, 125 preferentially differ depending on the location of the guide 120a, 120b, 120d in the jaw. The thicknesses e1, e2 are e.g. greater when the guide 120a, 120b, 120d is arranged at the molars than when the guide 120a, 120b, 120d is arranged at the incisors.

All numerical data are given as an example only. The numerical data provide the trainee dentist with the best representation of the feeling that he/she should feel when treating a human patient.

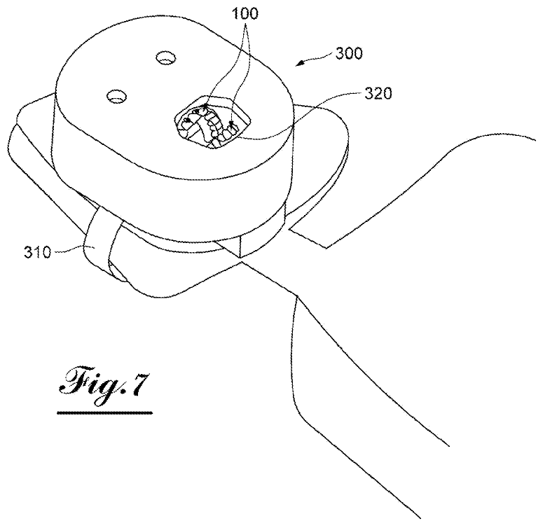

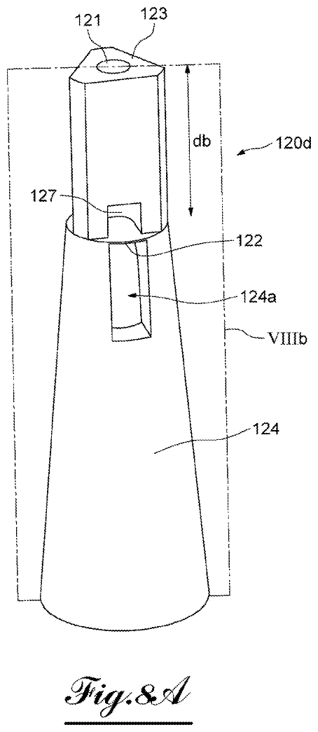

FIG. 7 shows a setup for simulating at least one anesthesia technique.

The setup comprises a circumoral region model 300 and at least one anatomical model 100 of a maxilla, comprising at least one guide 120a, 120b, 120c, 120d.

The circumoral region model 300 comprises an opening 320 for exposing the at least one anatomical model 100 of the maxilla.

The anatomical model 100 comprises, according to one embodiment, at least one means 140 of rigid attachment to the model 300 of the circumoral area. Thus, the anatomical models 100 can be changed once the anesthesias were performed.

The anatomical model 100 further comprises, according to one embodiment, at least one means 150 for association with another anatomical model 100. The above can be used for giving the jaw an adequate opening angle and for reinforcing the strength of the anatomical models 100 of a maxilla.

The circumoral area model 300 preferentially further comprises a means 310 of spatial attachment. The means of attachment 310 is e.g. a hook-and-loop or elastic band for attachment to the head plate of a dentist's chair. Thus, the real conditions of a dental office can be recreated.

The circumoral zone model 300 is advantageously made of a material which is soft and sufficiently elastic enough to represent the cheeks of a patient.

According to one embodiment, the circumoral area model 300 is made of polyurethane foam.

1. An anatomical model of a maxilla of a living being comprising a gingiva representing the maxilla of said living being, the anatomical model being wherein same comprises at least one guide for a tool integrated into the gingiva to allow an operator to simulate a dentistry gesture.

2. The anatomical model according to claim 1, wherein the guide (120a; 120b; 120d) crosses through the gingiva and comprises a slide for orienting a needle extending into the gingiva and forming a substantially cylindrical hole through the gingiva.

3. The anatomical model according to claim 2, wherein the guide (120a; 120b; 120d) comprises a main inner wall arranged in the slide across said hole so that a needle inserted into the slide perforates the main inner wall.

4. The anatomical model according to claim 2, wherein the guide comprises a wall protecting the free end of the needle, the protective wall being aligned with the hole formed by the slide and being arranged downstream of the slide along the direction of insertion of the needle.

5. The anatomical model according to claim 1, wherein same comprises at least one tooth arranged on the gingiva.

6. The anatomical model according to claim 5 when dependent on claim 3, wherein the guide (120a) comprises at least one secondary inner wall arranged in the slide across said hole, the secondary inner wall being arranged downstream of the main inner wall along the direction of insertion of the needle, so that a needle inserted into the slide perforates the main inner wall first and then the secondary inner wall.

7. The anatomical model according to claim 1, wherein the guide (120a; 120b; 120d) comprises a stop aligned with the hole formed by the slide and arranged upstream of the slide along the direction of insertion of the tool.

8. The anatomical model according to claim 7, wherein the protective wall comprises a window (124a) for viewing the free end of the needle.

9. A setup for simulating anesthesia techniques, the setup comprising an anatomical model of an upper jaw of a living being and an anatomical model of a lower jaw of a living being according to claim 1, and a model of a circumoral area of the living being, each anatomical model comprising means of rigid attachment to the circumoral area model, the circumoral area model comprising a means of spatial attachment and an opening allowing the two anatomical models to be seen.

10. A method for simulating anesthesia techniques, the method comprising inserting the needle of a syringe into a hole of a gingiva representing a maxilla of a living being, the hole being formed by a slide of a guide integrated into the gingiva, a perforation of a main inner wall of the guide, the main inner wall being arranged in the slide across said hole, and a view of the free end of the syringe through a viewing window (124a).
